(19) United States
(12) Patent Application Publication
(10) Pub. No.: US 2022/0291752 A1
(43) Pub. Date: Sep. 15, 2022

(54) Distributed Application Platform Projected on a Secondary Display for Entertainment, Gaming and Learning with Intelligent Gesture Interactions and Complex Input Composition for Control

(71) Applicant: Von Clausewitz Systems, LLC, Atlanta, GA (US)

(72) Inventor: Ifeanyichukwu Agu, Atlanta, GA (US)

(73) Assignee: Von Clausewitz Systems, LLC, Atlanta, GA (US)

(21) Appl. No.: 17/261,007

(22) PCT Filed: Jan. 16, 2020
(86) PCT No.: PCT/US2020/013851

§ 371 Date: Jan. 16, 2021

(51) Int. Cl. G06F 3/01; G06V 40/20; G06V 20/40; G06V 10/70; A63F 13/428; A63F 13/213; A63F 13/211; A63F 13/327; A63F 13/92

(52) U.S. Cl. CPC G06F 3/017; G06V 40/20; G06V 20/46; G06V 10/70; A63F 13/428; A63F 13/213; A63F 13/211; A63F 13/327; A63F 13/92

(57) ABSTRACT

A method of interacting with a mobile computing device and a secondary device comprising configuring a distributed application platform on the mobile computing device to receive a gesture input by a video stream, convert it into multiple frames wherein each frame is extracted and particular predefined gestures are identified based on spatiotemporal features of the stream of frames, the gestures, when used in isolation, act as an input to the distributed application, which by extension includes the mobile device, without physically touching, to control interaction of the end user with the mobile computing device and displaying output to a secondary display device with network functionality, the platform also allowing for the user to compose complex control flows originating and spanning several devices and their integrated sensors by combining input from multiple sensors on multiple devices.

### CLAIM OF PRIORITY

This application is a national stage application, filed under 35 U.S.C. § 371, of International Patent Application No. PCT/US2020/013851, filed on Jan. 16, 2020, which is incorporated by reference herein in its entirety.

The present invention relates to a distributed application and platform running on portable networked devices (like mobile phones, smart watches, smart TVs, etc) using their sensors and displays to participate in the delivery of distributed application features. The application assumes a TV as its primary display and allows for multi-factor control from device sensors. The platform of the present invention allows the primary display, a “smart” television, to display content from the networked devices over the network and to receive complex control input from a user through input flows spanning the variety of sensors on one or more of the networked devices, chief among which is machine-learning mediated sensor input like gesture recognition from a camera sensor stream. These gestures detected from the physical movements of the user can be leveraged for application control without the user having to physically touch the networked devices. In addition, these detected gestures are used in combination with input from other sensors present in one or more of the other networked devices to compose complex control flows that greatly expand the control-input-bandwidth of the user.

### TECHNICAL FIELD

The present invention further relates to a novel method of providing a user interface for a mobile device equipped with a video camera.

### BACKGROUND

Personal portable electronic devices like; smart watches, mobile devices, digital assistants and smart TVs offer a lot of networked features but rarely do we see applications take advantage of this interoperability in the delivery of novel distributed applications. These devices often come with different sensors that complement each other nicely and can deliver compounded value in combination. One such use case is in television based gaming. Television- based gaming has mostly been the purview of the gaming console or the personal computer. In recent years, there has been a surge in the mobile gaming market with its main draw being play on demand anywhere. Despite these efforts to democratize gaming, television-based interactive entertainment still presents several barriers to entry for the average non-gamer. Some of these barriers include: (1) proprietary controls: to game successfully on any established platform one must first learn to be deft on the proprietary controls made for the platform. Granted, consoles now allow physical interactions through the use of separate motion controllers like the Xbox Kinect and Playstation Move, however, these are typically not the primary input medium but rather accessories that must be purchased separately; (2) expensive equipment required: a non- gamer trying to get into gaming has to first make a significant investment to buy a console or PC; and (3) complicated setup: Setting up the gaming console or PC for gaming involves quite a bit of sophistication and experience with portable electronics.

Rapid improvements in mobile microprocessor technology (multi-core chip-sets and GPUs) and machine learning algorithms have reduced the barriers of entry required to deliver decent quality gaming/entertainment from or off of a mobile device projecting on a secondary display.

In addition, it has made near real-time machine learning ‘inferencing’ of reasonably large datasets possible. A use case of the invention presented here, permits any average mobile device user (not a gaming aficionado) to turn their television into a gaming system and intuitively interact or play with the applications without needing to learn to use any proprietary controls.

Within the last few years, a mirroring service for sharing an image between two devices has been developed and has come into widespread use. The mirroring service is provided using a source device for providing image information and an image display device or sink device for outputting the received image information. The mirroring service conveniently allows a user to share all or a portion of the screens of the two devices by displaying the screen of the source device on the screen of the sink device (or on a portion of the screen of the sink device). This mirroring service can be used as the basis of producing output on the primary display. In that scenario, the content on the mirrored device's display and that of the mirroring TV (sink device) are identical. The present invention provides a method for providing a user interface to control the distributed application presented as a unified platform hosted by a series of networked devices. This includes and is not limited to control of the mobile terminal by a user who is viewing the screen of the mobile terminal as it is mirrored or displayed upon the sink device which does not require the user to touch or provide input through the mobile terminal, the sink device, or any other remote controller device for either the mobile terminal or sink device. The platform of the present invention also does not require the user to operatively connect any accessory, controller, or input devices to receive the input, such as the Kinect device for an Xbox. The Kinect device is motion sensor add-on for the Microsoft Xbox 360gaming console. The motion sensor device provides a natural user interface (NUI) that allows users to interact with the gaming console intuitively and without any intermediary device, such as a controller. In addition to mirroring a mobile application on a sink device, so called “Smart TVs” have the capability of running applications. Such smart TV apps, typically written as web applications in HTML or other appropriate languages, can be coupled by a variety of communicative means with an assortment of devices to offer a cohesive application experience by distributed modules running on disparate devices (having myriad sensors) and collaboratively delivering application features. The present invention provides a method for modular distribution of application features and corresponding computation across networked devices. Also presented is a method to control application features by means of coherent complex control flows originating on an initiator device on a network, progressing through zero or more devices and terminating on a separate device (typically the primary display).

Examples of suitable source devices include a mobile device having a number of input sensors, including a relatively small screen, and configured to easily receive a user command, such as a mobile telephone or tablet computer, the screens of which allow for a user to input a command to the mobile device by touching or swiping the screen. Examples of the sink device include an image display device having a relatively larger screen and being capable of receiving input over a network, such as a typical “smart” television or monitor. Sink devices may also be equipped with “picture-in-picture” capabilities that allow two or more different streams of video content to be displayed simultaneously on the screen of the sink device.

U.S. Pat. No. 10,282,050 titled “Mobile Terminal, Image Display Device and User Interface Provision Method Using The Same,” the disclosure of which is incorporated into this specification by reference, is directed to a mobile terminal, an image display device and a user interface provision method using the same, which are capable of allowing a user to control mobile terminals via the screens of the mobile terminals output on the image display device and allowing the user to efficiently control the mobile terminal by interacting with the images output on the image display device using the input device of the image display device. In other words, U.S. Pat. No. 10,282,050 allows a user to efficiently control mobile terminals via the screens of mobile terminals that are output on the image display device by manipulating the user input device of the image display device (i.e., via the remote control unit of the television).

The present invention includes a use-case that eliminates the need for the user to physically interact with either the mobile terminal, the image display device, or the user input device of the image display device.

### SUMMARY OF THE INVENTION

The platform of the present invention is a distributed mobile entertainment application that employs the use of a mobile device, sometimes referred to herein as a mobile terminal, a “smart” television set or other wireless-enabled secondary display device to deliver entertainment and gaming without the need for direct contact by the user with either the mobile terminal, the image display device, or any other user input device. The platform attempts to solve all these aforementioned problems in one product. Using machine learning algorithms for visual image processing, the platform permits total novice non-gamers to intelligently interact with the application. It does not require any additional expensive pieces of equipment or remote controllers; all it requires is the mobile device, and a modern smart television with network features. No complicated setups are needed.

An interactive platform for a mobile device or a mobile terminal with a dedicated application configured to receive plurality of video streams from the camera module of the mobile device. The app receives the video streams converts it into multiple frames wherein each frame is extracted and particular predefined gestures are identified based on select spatiotemporal features of the stream of frames. The identified gesture when used in isolation can act as input to the distributed application which by extension includes the mobile device, without physically touching, to control interaction of the end user with the mobile computing device and displaying output to a secondary display device with network functionality. The platform also allows for the user to compose complex control flows originating and spanning several devices and their integrated sensors by combining input from multiple sensors on multiple devices. For example; this could include flows initiated/triggered by a physical gesture detected from multiple frames of the video stream, and complemented by a touch gesture on the touch screen of a networked device participating in the distributed application. Another example could be a control flow originated by the users speech on the microphone of a networked device and complemented by the accelerometer on another networked device. A concrete use-case of the last mentioned example would be a scenario where a user says “control brightness” into the microphone of a smart watch participating in the networked distributed application and this voice command triggers the display of a brightness control graphic on the primary display and a mobile phone also participating in the distributed aplication uses its tilt via the accelerometer sensor to adjust the brightness.

The platform of the present invention can be utilized as a mobile entertainment application that employs the use of a mobile device, a “smart” television set or other network- enabled secondary display device to deliver entertainment and gaming without the need for direct contact by the user with either the mobile terminal, the image display device, or any other user input device.

The distributed application can act as input for a secondary application, also possibly running on the mobile device and displayed on the screen of a separate device. For example; it can be used as a gesture input device for a personal computer, with which it can enable interactive entertainment. A second example could be a scenario where it could be used as an input device for a smart home application whereby the user's gestures or composed control flows enable quick control of household functions such as turning lights on or off, controlling light dimming or hues, audio components, security components, air conditioning and humidity settings, or any other of the range of control feature-sets available in a smart home environment.

The platform of the present invention can be used for augmented reality gaming. Using the camera as the primary input device allows for the platform to place overlays on the primary video stream. These graphical overlays can form the basis for augmented reality gaming. By intelligently placing overlays on environment features in the video stream, the end user can interact with the overlays via gestures, and the platform can deliver an AR experience. Similarly, the composite product is a mobile platform capable of deciphering gestures and human body poses to interact with graphical overlays in the environment captured by the mobile device's camera constituting an augmented reality experience.

The platform of the present invention is also useful for easily enabling learning by mimicry. For example, it could be used to teach one or more users how to dance. This is made possible because the secondary display can display an instructor instructing on how to dance while simultaneously displaying video being taken of the the end user(s) using the mobile devices' camera on the same secondary display or screen, either as an overlay or as a picture-in- picture feature.

Furthermore, the platform of the present invention may also provide an alternative method of video conferencing. The secondary display could be used to display a live video feed from a calling party to a mobile device. This video conferencing feature can provide a social component to the distributed application to enrich the experience. For example, a yoga how-to instructive application that allows the user to compare their poses in real time with the instructor in the video via picture-in-picture views of the instructive video and the user's camera's video stream on the secondary display screen can be further enhanced by enabling friends to video conference picture-in-picture style while they all work out to the same yoga instruction video.

To achieve the objects and other advantages and in accordance with the purpose of the invention, as embodied and broadly described herein, in one use-case, mobile application platform is provided for projecting a source image from a mobile device onto a separate secondary display device and utilizing a machine learning-based visual process to evaluate a live video stream generated by the video camera of the mobile device and receive input from the user based upon the user's gestures, positioning, and other movements of the user's face and body. In another use-case, the display on the separate secondary display is not projected by the mobile application but rather is an application running on this display (typically a smart TV application). Control herein refers to user input composed across participating device sensors including deciphered gestures.

Other objectives and aspects of the invention will become apparent from the following detailed description, taken in conjunction with the accompanying drawings, which illustrate, by way of example, the features in accordance with embodiments of the invention.

Embodiments of the present invention may employ any or all of the exemplary aspects above. Those skilled in the art will further appreciate the above-noted features and advantages of the invention together with other important aspects thereof upon reading the detailed description that follows in conjunction with the drawings, which illustrate, by way of example, the features in accordance with embodiments of the invention. The summary is not intended to limit the scope of the invention, which is defined solely by the claims attached hereto.

### BRIEF DESCRIPTION OF THE DRAWINGS

Embodiments of the invention are described with reference to the following drawings, wherein:

FIG. 1 illustrates a setup of a platform according to the present invention;

FIG. 2 is an illustration of an illustrative set of key points from a human body pose estimation algorithm;

FIG. 3A illustrates an interaction of the user with mobile device, in wireless connection with a secondary device;

FIG. 3B illustrates an interaction of the user with a secondary device through the mobile device;

FIG. 3C illustrates an interaction of the user with a secondary device directly;

FIG. 4 is a flowchart of the core functionality of the platform;

FIG. 5 is a flowchart of a typical DLNA based wireless display;

FIG. 6 is an illustration of a Model View Controller (“MVC”) pattern useful for handling multiple displays; and

FIG. 7 is a flowchart of a gesture-based control input of the present invention.

### DETAILED DESCRIPTION

The present invention involves a method of interaction of a user with a distributed application via composed sensory input including machine learning deciphered gestures. The core functionality of the application or platform involves using machine learning-based visual processing of a live video stream captured by the mobile device's camera in conjunction with input from sensors from networked devices participating in the distributed application to allow for intelligent interaction between the human end user and the distributed application. This intelligent interaction is enabled by the ability of the application to decipher human poses and gestures as they are captured through a live video stream and use this in concert with other user input to allow for high fidelity intuitive control. Consequently, the end user can, for example, select menu options by pointing to a menu item displayed on a secondary screen or control avatars on a display screen that mimic whatever gesture the end user performs. So if the user jumps, the avatar jumps, etc. The nature of the interaction will depend upon the desired program selected by the end user, run on the mobile terminal, and displayed on the secondary screen.

The gesture recognition component of these interactive controls can be achieved using any of a suite of commonly available machine learning libraries and associated models including but not limited to “human pose estimation” models with machine learning libraries like Google's TensorFlow. The actual computation done in service of the gesture recognition can be handled in a variety of ways. (a) it could be done exclusively on one participating networked device like the mobile device which captures the video frames or (b) the sink device displaying the video frames or using the interpreted gestures for control. (d) On a low-latency cloud service. (c) Alternatively, it could be a collaborative effort between participating devices. For example, the mobile device might run a model for “full body pose estimation” while the Smart TV runs a model for “hand pose estimation.”

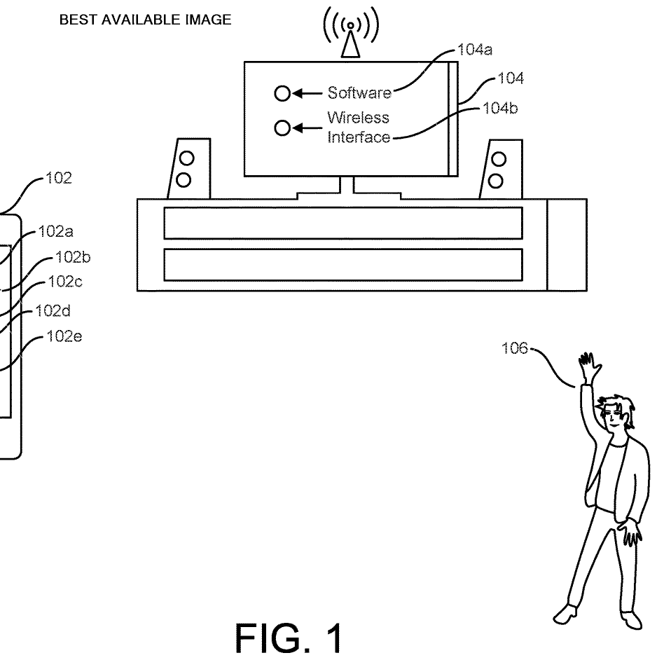

FIG. 1 illustrates a setup 100 of a platform according to the present invention showing a mobile device 102 on stand, a secondary display 104 showing live content, and a user 106 interacting with gestures. The complementary set of technologies that completes the platform of the present invention further comprises a means to transmit the display of the mobile device 102 to a display screen of the secondary or secondary display device 104, preferably a television set comprising a wireless network interface, said secondary display device configured to receive video data through the wireless network interface, and to display video data received through the wireless network interface on its screen. Alternatively, this secondary display interface could be running an application which communicates with the other participating networked devices via full duplex network protocols like websockets, TCP, etc.

The present invention particularly includes a system 100 for displaying an output on the secondary display device 104. The system 100 comprises a mobile computing device 104 wherein the mobile computing device 102 is a smart phone, i-pad, laptop or else. The mobile computing device 102 includes a camera 102a for receiving an input, a processor 102b for processing the input to generate a plurality of frames. Each of the frame is integrated to generate a processed input and a software platform 102c for comparing the processed input. In the first embodiment the input is a video of a user. In the other embodiment the input can be single or multiple pictures. In yet another embodiment the input is a live video stream. The comparison of an estimation data is evaluated through plurality of motion sensors 102d in the mobile computing device to further estimate a human pose to generate a final output. Moreover, the final output is displayed on secondary display 104 which is primarily a television unit or else any other display unit alternatively. The mobile computing device 102 also includes a wireless interface module 102e for transmitting the output to the secondary display 104 from the mobile computing device 102. The secondary display 104 may also include a software application 104a and a wireless interface module 104b for communication. This can be accomplished by using a variety of available wireless standards. The following are non-exclusive examples of some of the wireless standards that can be used:

(1) Google's Chromecast: the mobile phone can project the contents of its display on any google chrome cast enabled/connected device via the google chrome cast presentation API;
(2) DLNA or UPNP: the mobile device can open up a stream between itself and a DLNA or UPNP enabled device to stream its display onto the screen of the television set;
(3) Other proprietary standards: There are several wireless standards for video transmission from a mobile device to an image display device. Any one of these commonly available standards may be used as the transport means to display the visual display of the mobile device to the secondary display device where it is displayed on the screen of the image display device.
(4) The mobile device does not transmit output to the secondary display device as the secondary display device runs its own application. In this scenario the mobile device transmits controls to the running application on secondary display device.

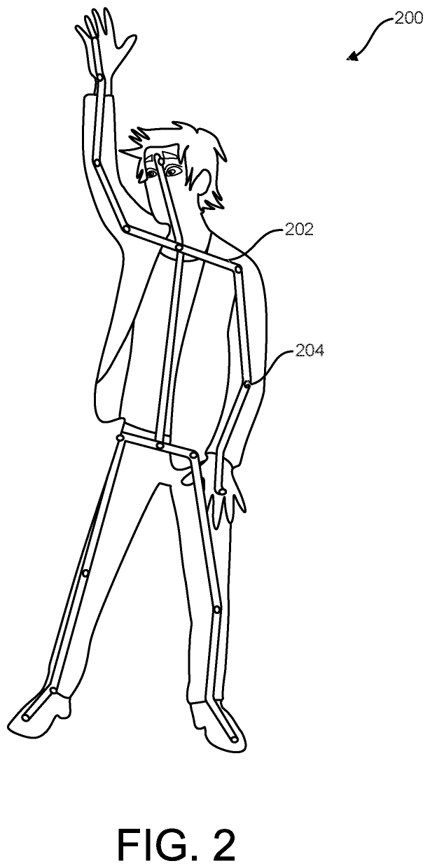

FIG. 2 is an illustration of an illustrative set of key points from a human body 200 pose estimation algorithm 202. The key-points labeling refers to best guesses of key human body parts (shown as dots) from an inferred heatmap of probabilities. Any reasonable machine learning framework capable of near real-time (sub-100 millisecond) inferencing/predicting of the individual video frames (like a convoluntional neural network model running on a Keras library) can be used to provide human body key points labeling per frame.

In one use-case of in the described platform, the video camera from a networked participant captures a stream of sequential images, and the human pose estimation algorithm 202 tracks and analyzes each frame or sequential image for a predetermined set of key points 204 corresponding to different body parts such as fingers, joints, knuckles, elbows, knees, waist, shoulders, wrists, ankles, chin, cheekbones, jaw bones, ears, eyes, eyelids, eyebrows, irises and the like. By tracking and processing these key-points in real-time per frame, the gestures being made by the user can be interpreted and correlated with the image being displayed on the screen of the image display device. Note that it is not necessary in most cases for every sequential image to be analyzed. Instead, based upon the frame rate and processor speeds and capabilities of the mobile device, and also upon the nature of the secondary application being delivered, the human pose estimation module may be able to adequately function by analyzing one frame out of every two, three, four or more captured as opposed to every frame.

In another use-case described in this platform, the microphone from a networked participant in the distributed application captures the users speech and using machine-learning techniques converts this speech to text which is displayed on the secondary display in real-time as the speech is being converted to text. When this conversation process encounters ambiguous speech it presents the user with a visual interface depicting a list of probable converted textual options of the specific equivocal speech snippet. Simultaneously, the user is able to select via gestures, as described above, the intended/correct text/phrase from the list of provided options allowing for accurate conversion of the user's uttered speech. This example also represents the complex control flow composition capable within the distributed application that allows orchestration of sensory input from multiple networked devices into a fused, coherent, concerted control effort. In yet another use case, a user might speak to a digital assistant participant in the distributed application a specific command while pointing to a target for control. For example, the user might utter the phrase “Digital assistant change the hue of this smart light-bulb to lime green” while pointing to a specific light-bulb. Or alternatively, “Digital assistant control this device” while pointing to a participant device. The first phrase could have the effect of the control command being directed to the appropriate target device and the second phrase could have the effect of the target participant device offering/describing interfaces for control. In the former example, involving the light-bulb, the described effect could be achieved by using a combination of machine learning techniques. For instance, pose estimation can aid in a disambiguation effort in combination with an image classifier to match the target device with a predefined image to unique identifier map.

Interpreting the gestures or movements of the subject and relating those gestures or movements to the inputs available in the application being run on the mobile device 102 allows the user 106 to operate the application 102c through the gesture or movement input. The screen of the mobile device 102 may be mirrored on the screen of the secondary display device 104 (both screens displaying the same content), or the screen of the mobile device 102 may be wirelessly transmitted to the screen of the image display device or the secondary display device may be running an application which receives control and data from other networked devices participating in the distributed application. In this scenario the display is not a projection from the mobile device or a mirroring of the mobile device but a full blown application. This application running on the secondary device can choose to incorporate anything in its display include anything transmitted by the mobile device.

In using the platform 100 of the present invention, the video content data displayed on the screen of the secondary display device 104 is not mandatorily a mirror of the mobile device's 102 screen (when mirroring the screens, the model view controller design pattern (MVC) is useful in separating the display and the data and allowing modification in each data without affecting the other). While both the mobile device and the secondary display 104 could have the same visual content persistently mirrored, the platform of the present invention may also be configured to display a first content data on the screen of the mobile device 102 and a second content data on the screen of the secondary display device 104. In one current implementation of the platform, the camera's 102a video stream is not displayed on the mobile device 102, rather it is only displayed on the secondary display device 104, leaving the screen of the mobile device 102 available to show other static or video content.

In addition, when menu options of the secondary app are presented, they are displayed differently on both the screen of the mobile device and the screen of the secondary device to take advantage of differences in form factors as a means of selection. The user can choose to select a menu by the typical means of touching the menu item on the screen of the mobile device 102 or selecting the desired menu by gestures associated with the display on the secondary device 104. The program 102c running on the mobile device 102 would then carry out the instruction received through either form or manner of input. Consequently, the nature of the output on the networked devices can be entirely independent and orthogonal to one another or could be tightly coupled and mirror one another.

The machine-learning gesture detection module 202 or process of the present invention is primarily in 2 dimensions but alternatively it can be in a 3 dimensional pose estimation to track the end users' depth/distance as well. Most human pose estimation or gesture detection techniques rely on key-pointers represented in either a two dimensional (2D) or three dimensional (3D) coordinate system. Based on the relative motion (temporal features) of these, the nature of the gesture can be detected with a high accuracy, depending on the quality of the input captured through the camera 102a (or cameras) of the mobile device 102.

In some embodiments, mobile devices 102 may also comprise inertial measurement units (IMUs) which may further enhance the accuracy of the capture and tracking of gestures and thus improve the interface with the mobile device. On such mobile devices, the key point human pose estimation data generated from the images captured by a camera of the mobile device 102 can be compared and supplemented by a contemporaneous evaluation of the gesture movement data taken by these motion sensors 102d.

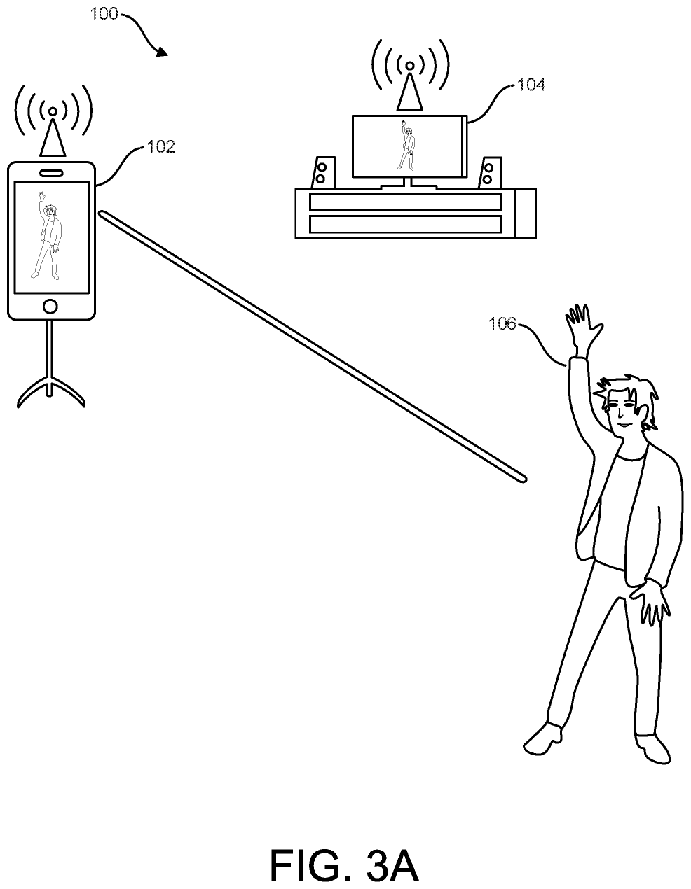

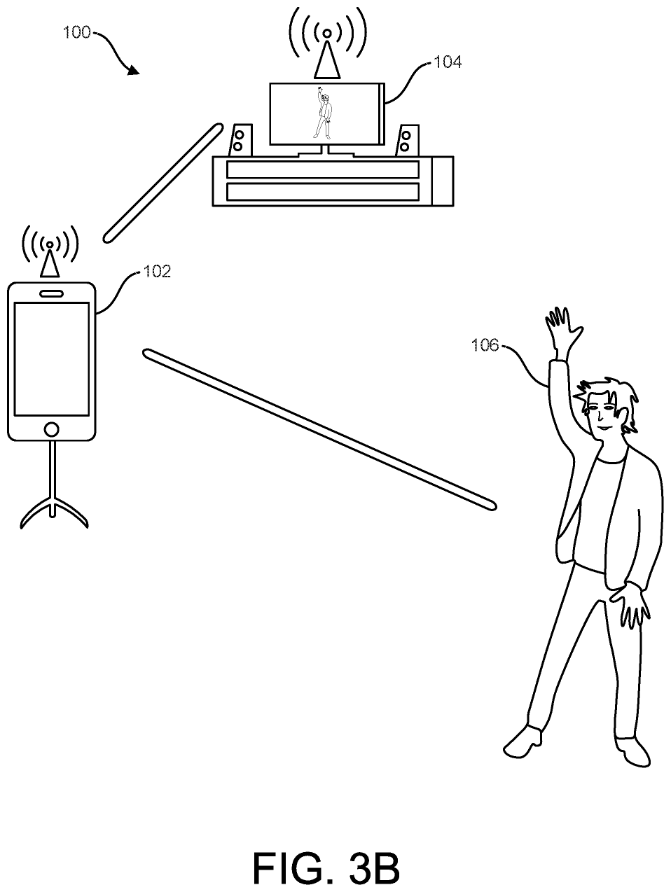

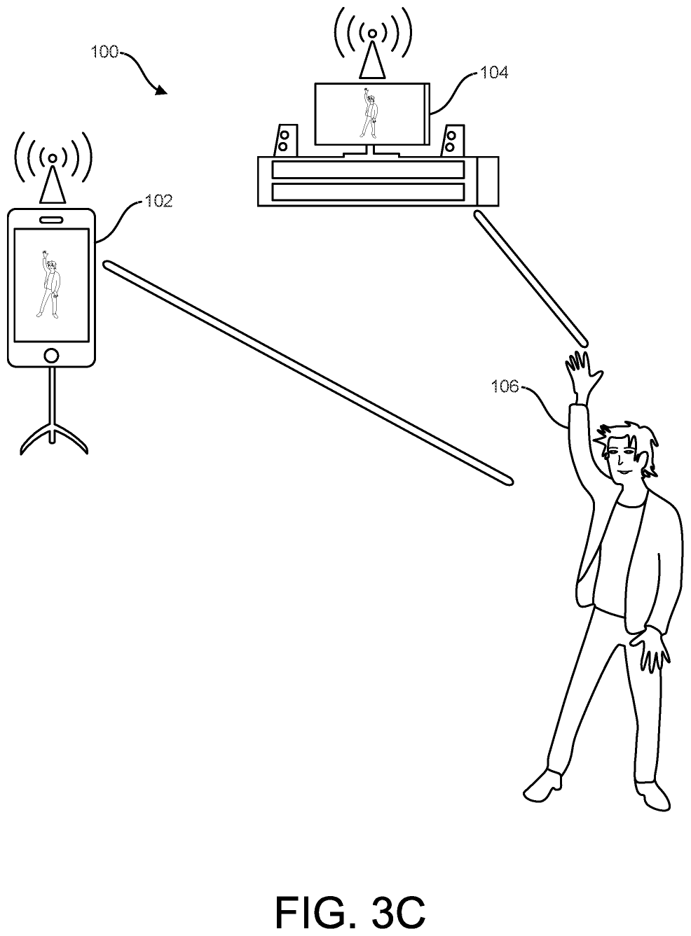

FIG. 3A illustrates an interaction of the user with mobile device in connection with a secondary device. The interaction with a mobile computing device 102 includes capturing the input from the camera 102a of the mobile computing device 102 and generating multiple frames through it to mark the key-point on the frames through a model running on a machine-learning library like a “pose estimation” CNN model on Google's tensorflow library 202. Further, the model evaluates or else processes the key points to recognize the gesture of the user 106. After the gesture is recognized, the interaction of the user 106 with the mobile computing device 102 occurs with an intelligently deciphered human gesture control process configured with the application platform 102c. The platform 102c running on a mobile device or networked participant devices 102 can act as an independent input device for a secondary application, possibly also running on the mobile device or participating in the distributed application 102 and displayed on the screen of a separate device, wherein the secondary application can be any gaming application or something else. The secondary application is also in communication with the networked participant devices i.e., mobile computing devices 102. So, the user can play a game in the mobile device through gesture recognition.

FIG. 3B illustrates an interaction of the user with a secondary device through the mobile device. The interaction with a mobile computing device 102 includes capturing the input from the camera 102a of the mobile computing device 102 and generating multiple frames through it to mark the key point on the frames through a machine-learning model like human pose estimation or hand pose estimation or some other plausible model that can contribute to the gesture recognition effort. Further, the models, human pose estimation and/or other models, evaluates or else processes the key points to recognize the gesture of the user. After the gesture is recognized, the interaction of the user 106 with the mobile computing device occurs with an intelligently deciphered human gesture control process configured with the application platform 102c. The platform running 102c on a mobile device 102 can act as an independent input device for a secondary application, also running on the mobile device and displayed on the screen of a separate device, wherein the secondary application can be any gaming application or else. The secondary application is also configured in the mobile computing device or in the secondary display. Further, in the first embodiment, the gestures are recognized by the mobile computing device 102 and the final action can be seen on both the mobile computing device 102 and the secondary display 104. This gesture recognition computational effort can be distributed among processors of networked devices participating in the distributed application including the secondary display. In the other embodiment, the final action is derived on the mobile computing device 102 but displayed on the secondary display 104. So, the user can play a game in the mobile device 102 through gesture recognition. Primarily, the independent input device can be used as a gesture input device for a personal computer, with which it can enable interactive entertainment. Alternatively, there can be a scenario where it could be used as an input device for a smart home application whereby the user's gestures enable quick control of household functions such as turning lights on or off, controlling light dimming or hues, audio components, security components, air conditioning and humidity settings, or any other of the range of control feature-sets available in a smart home environment.

FIG. 3C illustrates an interaction of the user with a secondary device directly. After the gesture is recognized, the interaction of the user with the mobile computing device 102 occurs with an intelligently deciphered human gesture control process configured with the application platform 102c. The platform 102c running on a mobile device 102 can act as an independent input device for a secondary application, also running on the mobile device 102 and displayed on the screen of a separate device, wherein the secondary application can be any gaming application or else. The secondary application is present on a secondary display 104 wherein the secondary display 104 is a television unit. Further, the gesture is directly recognized by the secondary display. The gesture can be used for menu selection, playing games, avatar creation or else.

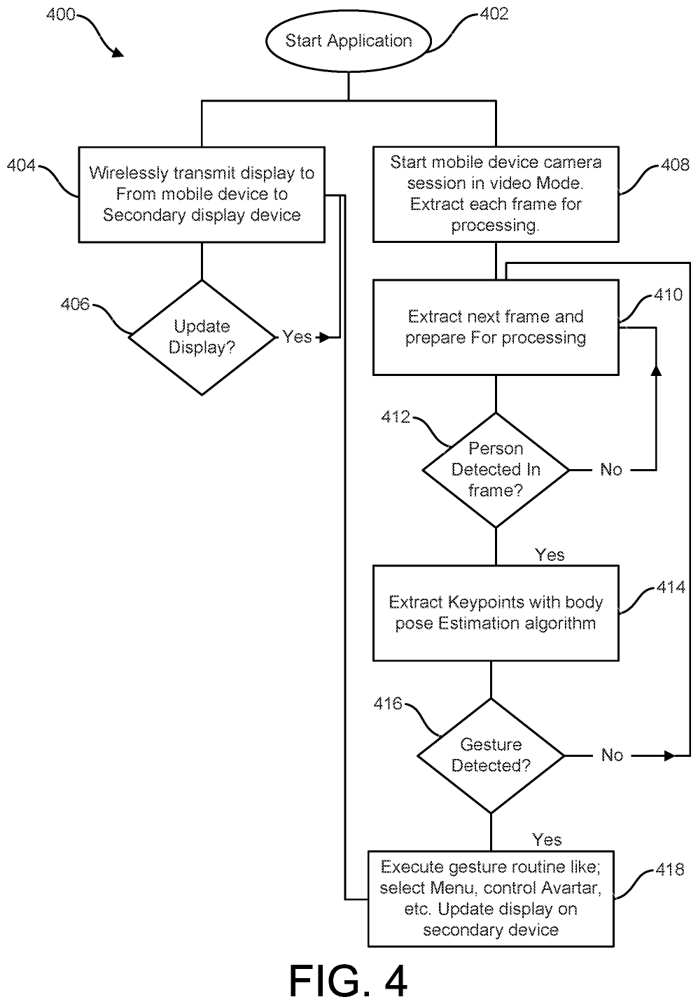

FIG. 4 is a flowchart of the core functionality of the platform 400 of the present invention. The platform is initiated on a mobile device, the parallel processing operations begin 402. One parallel operation engages the a wireless network interface of the mobile device, to wirelessly transmit the screen display of the mobile device and/or control inputs to the wireless network interface of a secondary display device or other networked participants 404 which has been configured to display image content received from a mobile device or is running an application. As long as the platform is active, the screen display of the mobile device is continuously transmitted to be displayed or mirrored on the screen (or a portion of the screen) of the image display device 406. When mirroring is enabled, if the foreground app running on the mobile device changes the image displayed on the screen of the mobile device, the image displayed on the screen of the secondary display device changes as it is mirrored. Because of the processing speeds of the devices used, to the human eye the screen mirroring is effectively simultaneous and continuous.

The other or second parallel processing operation is the initiation of a mobile device camera session in video mode 408. Each frame or image captured by the camera is extracted and prepared for image analysis processing 410. If the analysis of the frame detects a person 412, the operation proceeds, otherwise the operation continually extracts and analyzes each frame until a person or the desired portion or part of a person's body is detected 414.

The detection of a person or relevant part thereof triggers a next step of the second parallel processing operation wherein key points are extracted with machine-learning models that produce outputs like, but not limited to, “body pose estimation” key points and “hand pose estimation” key-points. These key-points are fed to other models that detect certain gestures in individual frames like a thumbs up or a peace sign. Alternatively the key-points are buffered and fed to yet another model for temporal feature extraction like motion based gestures; for example a left hand swipe. These downstream models analyze buffered or un- buffered output from upstream models until a gesture is confirmed. This gesture recognition mechanism is not limited to this specific architecture consisting of a pipeline of machine learning models but illustrates a possible implementation. The set of gestures or movements which are sought by the downstream model's step are predetermined based upon the specific app then running as the initiating/foreground app of the mobile device. The entirety of gesture algorithm is configured to factor into its analysis the positions of the operable portions of the screen that are receptive to user input. The positioning of the operable portions of the screen will vary depending upon the secondary app being run. In other words, the body pose estimation algorithm will detect the areas of the screen of the mobile device through which the user is supposed to interact with the secondary app and will then analyze the user's movements and gestures in relation to these operative portions of the screen as displayed in the image or video content being displayed on the screen of the secondary display device in determining whether or not the gesture or movement detected correlates or corresponds to the type of interaction through which user input would be generated for and supplied to the secondary app on a touch screen.

Once an appropriate gesture or movement is detected 416, the execute gesture routine is activated in which the gesture or movement is converted into an input to the foreground or secondary app which will behave as it is programmed to behave in response to such input 418. For example, pointing to certain areas of the image displayed on the screen of the secondary display device will be interpreted and executed by the platform as an input to the foregound app corresponding to the user's touch on the corresponding portion or area of the screen of the mobile device. Having received such an input, the foreground app will react according to its programming. Such reaction of the foreground app most likely results in a change in the display, thereby initiating changes to the screen of the secondary display device being viewed by the user. In this manner, input to the foreground app can be made by the user as if buttons were pressed, avatars moved, control nobs turned, or such other resulting changes as if the user had physically interacted with the screen of the mobile device.

As the user provides gesture input via the platform to the foreground app running on the mobile device, the displayed screen changes leading to different interactions by the user. In this manner, the user can make use of the foreground app running on the mobile device and displayed on the screen of the larger secondary display device without physically touching the screen of the mobile device or using any other accessory controller device.

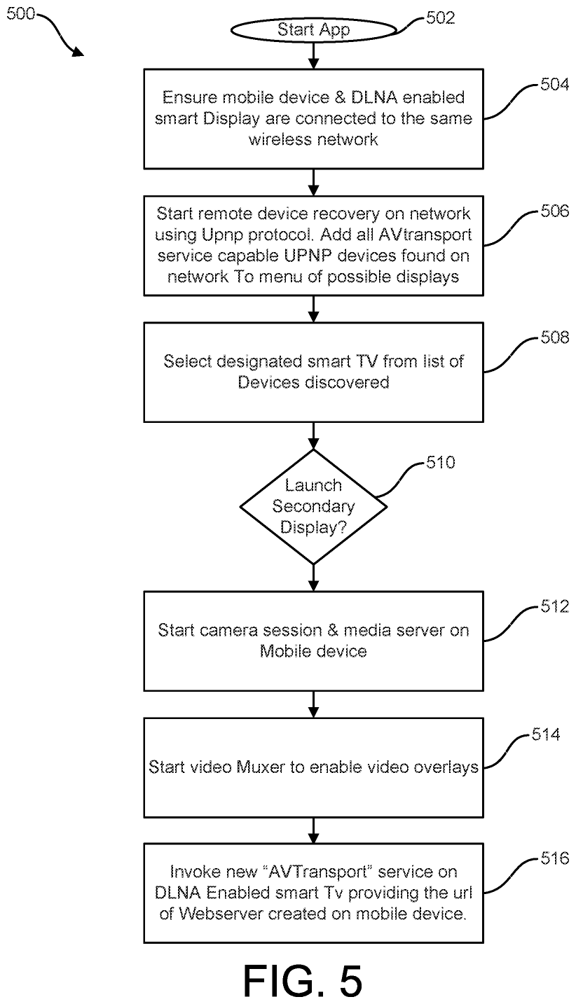

FIG. 5 is a flowchart 500 of a typical DLNA based wireless display. DLNA in an application 502 stands for “Digital Living Network Alliance” and is one of many competing standards used in the art for displaying or mirroring a device's screen wirelessly for media display on another screen 504, any one of which may be useful in the present invention.

DLNA uses Universal Plug and Play (UPnP) to take content on one device (such as a mobile device) and play it on another (such as a game console or a “smart” TV) 506. For example, a user can open Windows Media Player on a PC and use the Play to feature to play a video file from the PC's hard drive to an audio/video receiver connected to a television, such as a game console. Compatible devices automatically advertise themselves on the wireless network to which they are connected 508, so they will appear in the Play to the menu launched on the compatible device 510 without any further configuration needed. The device would then connect to the computer over the network and stream the media the user selected.

As illustrated in FIG. 4, when the platform of the present invention is launched on the mobile device, it verifies that it is wirelessly connected to a network and searches for at least one other DLNA-enabled image display devices that is connected to the same network. If no DLNA-enabled secondary display device is found connected to the network, the user is notified that no DLNA-enabled secondary display device could be found and asked to connect a DLNA-enabled secondary display device to the network.

Once both the mobile device running the platform and a DLNA-enabled secondary display device are detected on the same network, remote device recovery is begun on the network using UPnP protocol and all AVTransport service capable UpnP devices found on the network are added to a menu of possible displays and presented to the user. If multiple DLNA-enabled image display devices are found connected to the network, the user is notified to select one of the DLNA-enabled image display devices to utilize.

Next, the user selectes a specific DLNA-enabled secondary display device to use from the list of devices discovered. Then the user is invited to launch the secondary display 510, either shifting the A/V data from the screen of the mobile device to the screen of the image display device, or mirroring the screen of the mobile device on the screen of the image display device, or launching an application on the display which establishes communication links between the mobile device and other designated devices participating in the distributed application.

Upon launch of the secondary image display device, a camera session and the media service on the mobile device are begun 512.

Next a video muxer is begun to enable video overlays 514. A muxer is an engine or machine which will combine things such as signals in telecommunications. In media terminology, a muxer will combine media assets - subtitles, audio and videos - into a single output resulting in containers such as a mp4, mpg, avi, mkv. For example, an avi-muxer will combine video and sound into a *.avi file.

Finally, a new AV Transport service is invoked on the selected DLNA-enabled secondary display device 516 thereby providing the URL of the web server created on the mobile device. This allows the AV output from the mobile device to be displayed on the screen of the DLNA-enabled image display device.

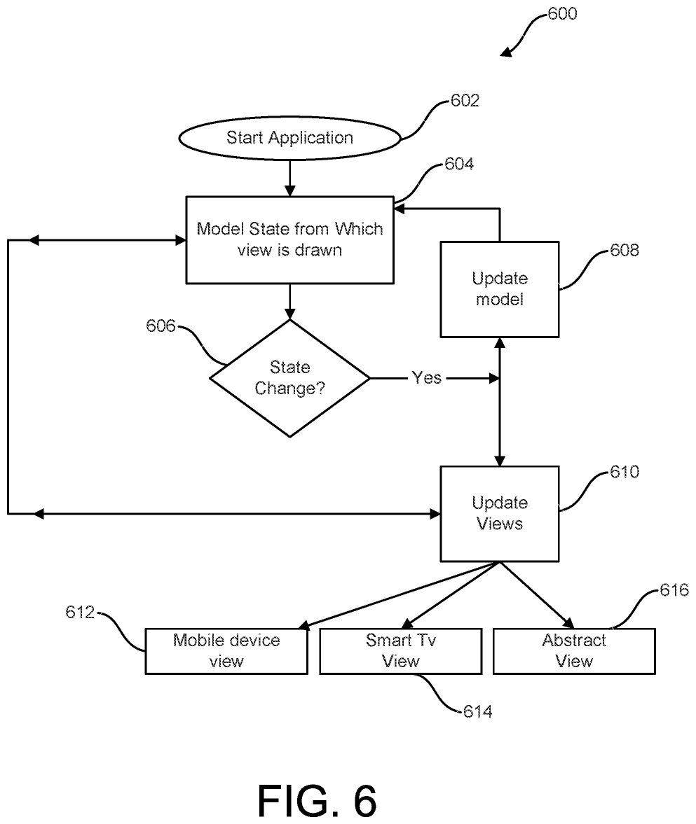

FIG. 6 is an illustration of a Model View Controller (“MVC”) pattern 600 useful for handling multiple displays. The Model View Controller (MVC) design pattern specifies that an application 602 comprises at least a data model, presentation information, and control information. The MVC design pattern requires that each of these be separated into different objects. As is well known in the art, MVC design patterns are essentially architectural patterns relating to the user interface / interaction layer of an application. Applications also generally will comprise at least a business logic layer, one or more service layers, and optionally a data access layer in addition to an MVC design pattern.

The platform of the present invention provides for MVC-based decoupled views, alternatively referred to as MVC-based loosely coupled views or simply MVC views. Mobile devices typically have significantly different display form factors from secondary display devices, such as smart televisions or monitors. Consequently, it has proved to be advantageous to use well-established MVC design patterns in developing the display subsystem. The platform of the present invention employs the use of the common MVC design pattern illustrated in FIG. 6 which among several benefits allows for decoupling the views 602. As a result, the eventual views or image information displayed on the secondary display device can be customized to benefit from the varying form factors of the physical display of different image display devices.

A preferred MVC design pattern illustrated in FIG. 6 employs a model to store the state of the application 604. This model provides the basis of views which the application can project. The controller, on the other hand, is responsible for mediating input from the end user and mutating or adjusting the state stored in the model 606. The views or screen types depicted in FIG. 6 are non-exhaustive representations of the types of displays with which the platform of the present invention can interact 608.

Using this pattern, the platform of the present invention allows for interactions with the controller from any of the provided views displayed. An end-user can interact with the application (control the application or provide input to it) by using the myriad of input functions (standard touch input / voice input for example) provided by the mobile device system functions or any of the participating networked devices. Alternatively, the end-user can interact with the platform using physical gestures visible on the secondary display device like a smart TV and deciphered from the camera video stream of the mobile device. Updates to the model(i.e., the model in the Model View Controller)from which the views derive their state can be made by either means of interaction with the system through the mobile device voice/touch input 610 or gestures deciphered from the information received by the mobile camera as the user interacts with the view displayed on a secondary display 612 (smart TV or VR reality goggle for example) or any other abstract view 614.

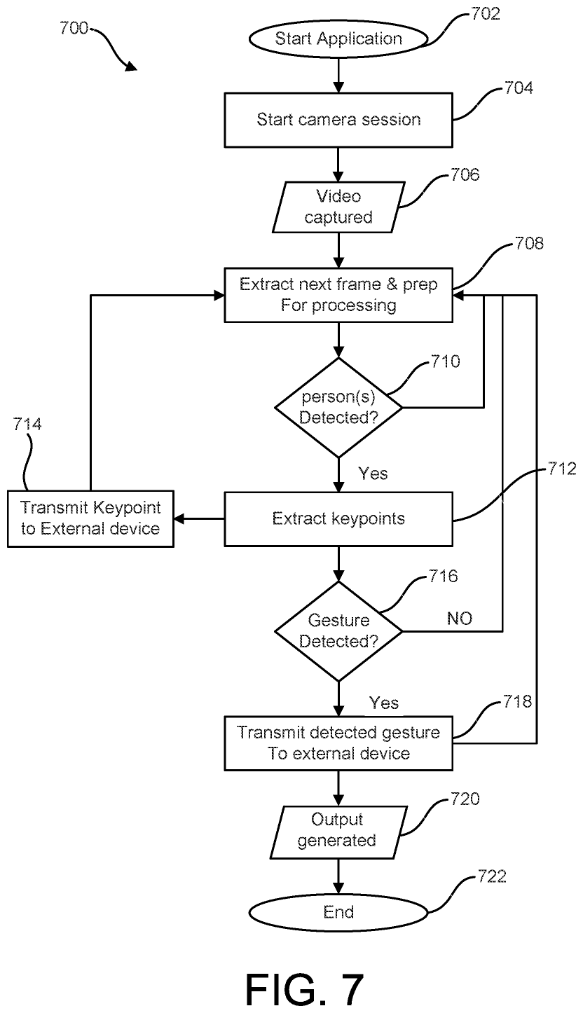

FIG. 7 is a method of a gesture-based control input 700 of the present invention. As described above in connection with FIG. 4, as soon as the application starts 702, the camera of the mobile device starts 704 to capture a live video stream 706 consisting of a series of image frames. As described above in more detail, every frame may be extracted and processed or only select frames 708. Returning to FIG. 7, if the analysis of the frame detects a person 710, the operation proceeds, otherwise the operation continually extracts and analyzes each frame until a person or the desired portion or part of a person's body is detected.

The detection of a person or relevant part thereof triggers a next step of the second parallel processing operation wherein key-points are extracted with a body pose estimation algorithm 712. The body pose estimation algorithm analyzes the key-points from a series of frames until a gesture is confirmed. The key-points may also transmitted to the external device directly 714.

Once an appropriate gesture or movement is detected 716, the execute gesture routine is activated in which the gesture or movement is converted into an input to the foreground or secondary app which will behave as it is programmed to behave in response to such input.

As the user provides gesture input via the platform to the foreground app running on the mobile device, the displayed screen changes leading to different interactions by the user. In this manner, the user can make use of the foreground app running on the mobile device and displayed on the screen of the larger secondary display device 718 without physically touching the screen of the mobile device or using any other accessory controller device, the output is generated 720 as the program ends 722.

While the various embodiments of the present invention have been described above, it should be understood that they have been presented by way of example only, and not of limitation. Likewise, the figure may depict an example architectural or other configuration for the invention, which is done to aid in understanding the features and functionality that can be included in the invention. The invention is not restricted to the illustrated example architectures or configurations, but the desired features can be implemented using a variety of alternative architectures and configurations.

Although the invention is described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the invention, whether or not such embodiments are described and whether or not such features are presented as being a part of a described embodiment. Thus the breadth and scope of the present invention should not be limited by any of the above-described exemplary embodiments.

The presence of broadening words and phrases such as “one or more,” “at least,” “but not limited to” or other like phrases in some instances shall not be read to mean that the narrower case is intended or required in instances where such broadening phrases may be absent.

I claim:

1. A method of interacting with a mobile computing device, the method comprising:
(a) configuring an application platform on the mobile computing device, wherein the application platform receives a gesture input by a camera;
(b) processing the gesture input by creating a plurality of frames, wherein each frame is labeled with one or more key points, further wherein each frame is integrated to generate a processed input;
(c) comparing the processed input with an estimation data evaluated by a plurality of motion sensors in the mobile computing device; and
(d) displaying an output on a secondary device, wherein the secondary device is wirelessly connected to the mobile computing device and wherein the secondary device is configured to collaboratively deliver an application feature of the application platform.

2. The method according to claim 1 wherein the interaction with the mobile computing device is with an intelligently deciphered human gesture control process configured with the application platform.

3. The method according to claim 1 wherein the processing of the gesture input and labeling of the key points is performed in real time per frame.

4. The method according to claim 1 wherein the secondary display is a smart television.

5. The method according to claim 4 wherein the secondary display is a DLNA-based wireless display.

6. The method according to claim 1 wherein the application platform processes the gesture input with a machine learning-based visual processing technique.

7. The method according to claim 1 wherein the application platform displays the output on the mobile computing device using MVC design patterns.

8. The method according to claim 1 wherein the step of processing the gesture input by creating a plurality of frames further comprises distributing the gesture input computation among the networked mobile computing device and the secondary device.

9. The method according to claim 1 wherein the processed input is received by a program integrated with the application platform to generate the output.

10. The method according to claim 9 wherein the program is a gaming application.

11. The method according to claim 1 wherein the mobile computing device receives the gesture input as a video stream.

12. The method according to claim 1 wherein the mobile computing device includes an inertial measurement unit (IMU) for enhancing accuracy of the gesture input.

13. The method according to claim 1 further comprising utilizing the processed input as an input for an application running on the secondary device.

14. A method for providing an input to a mobile device with a wireless network interface for transmitting an audio or a video data, a screen and a camera configured to capture the video data, said method comprising the steps of:
(a) connecting the wireless network interface of said mobile device to a network interface of a secondary image display device, said secondary image display device configured to receive the video data through the network interface of the secondary image display device, said secondary image display device further configured to display video data received through the network interface on a screen of said secondary image display device;
(b) capturing video data using the camera of the mobile device;
(c) transmitting captured video data to the network interface of the secondary image display device;
(d) displaying the captured video data on the screen of the secondary image display device;
(e) analyzing the captured video data using a human pose estimation module to interpret the physical movements of a user in relation to the captured video displayed on the screen of the secondary image display device; and
(f) providing input to the mobile device and the secondary image display device based upon the interpretation of the physical movements of the user captured in the video data.

15. The method of claim 14 further comprising the step of controlling an application running on a processor of the secondary image display device using input based upon the interpretation of the physical movements of the user captured in the video data.

16. A system for displaying an output on a secondary display device, the system comprising:
(a) a mobile computing device, wherein the mobile computing device comprises:
(b) a camera for receiving an input;
(c) a processor of the mobile computing device networked to a processor of the secondary display device for collaboratively processing the input to generate a plurality of frames, wherein each frame is integrated to generate a processed input;
(d) a software platform for comparing the processed input, wherein the comparison is performed with an estimation data evaluated by a plurality of motion sensors in the mobile computing device; further wherein an output is displayed based on the comparison; and
(e) a wireless interface module for transmitting the output on the secondary display device.

17. The system of claim 16 wherein the output is further utilized as an input for an application running on the secondary display device.

18. A computer program product comprising a computer useable medium having computer program logic recorded thereon for enabling a processor in a mobile computing device to interact, the computer program logic comprising:
(a) configuring an application platform collaboratively on the mobile computing device and a secondary computing device, wherein the secondary computing device is wirelessly connected to the mobile computing device,
(b) inputting a gesture inputt to the application platform, the gesture input received by a camera;
(b) processing the gesture input by creating a plurality of frames, wherein each frame is labeled with one or more key points, further wherein each frame is integrated to generate a processed input;
(c) comparing the processed input with an estimation data evaluated by a plurality of motion sensors in the mobile computing device; and
(d) displaying an output on the secondary computing device.

19. The computer program product of claim 18 wherein the computer program logic further comprises utilizing the processed input as an input for an application running on the secondary computing device.
